(19) United States
(12) Patent Application Publication
(10) Pub. No.: US 2025/0083749 A1
(43) Pub. Date: Mar. 13, 2025

(54) STRUCTURE FOR PREVENTING ROTATION OF A SIDE SILL

(71) Applicants: HYUNDAI MOTOR COMPANY, Seoul (KR); KIA CORPORATION, Seoul (KR)

(72) Inventors: Hyung-Jin Kim, Suwon-si (KR); Won-Ho Park, Ansan-si (KR)

(73) Assignees: HYUNDAI MOTOR COMPANY, Seoul (KR); KIA CORPORATION, Seoul (KR)

(21) Appl. No.: 18/436,297

(22) Filed: Feb. 8, 2024

(30) Foreign Application Priority Data
Sep. 7, 2023 (KR) 10-2023-0119117

(51) Int. Cl. B62D 25/02; B62D 21/15; B62D 27/02

(52) U.S. Cl. CPC B62D 25/025; B62D 21/157; B62D 27/02

(57) ABSTRACT

A structure for preventing a rotation of a side sill of a vehicle includes: a chassis frame, a vehicle body coupled to an upper portion of the chassis frame, and side sills formed on both end portions of the vehicle body in a width direction of the vehicle. In particular, the structure includes a rotation prevention pin fixed to the side sill. When a side collision occurs and the side sills are pushed in the width direction of the vehicle, the rotation prevention pin is coupled to the chassis frame and thus prevents the rotation of the side sill in the event of the side collision.

### CROSS-REFERENCE TO RELATED APPLICATION

This application claims priority to Korean Patent Application No. 10-2023-0119117, filed on Sep. 7, 2023, the entire contents of which are incorporated herein by reference.

### FIELD

The present disclosure relates to a structure for preventing a rotation of a side sill in which the side sill is coupled to a chassis frame of a vehicle to prevent the rotation of the side sill in the event of a side collision.

### BACKGROUND

The statements in this section merely provide background information related to the present disclosure and may not constitute prior art.

In a frame body vehicle in which a vehicle body is assembled to a chassis frame, the chassis frame and the vehicle body move individually in the event of a side collision.

In the frame body vehicle, the vehicle body is not firmly and mechanically attached to the chassis frame. Instead, a plurality of bushes made of an elastic material is provided on the chassis frame and the vehicle body is assembled to the chassis frame through bushes. Using the bushes has an advantage of insulating vibrations transmitted from a ground surface and the behavior of a vehicle.

However, since the chassis frame and the vehicle body are not firmly coupled, the chassis frame and the vehicle body may move individually in the event of the side collision. A reinforcement is applied to each of the chassis frame and the vehicle body, and a chassis frame side reinforcement and a vehicle body side reinforcement are individually deformed, resulting in excessive deformation.

Therefore, there is a problem in that in the event of the side collision, as the side sill of the vehicle body rotates, the vehicle body may be separated from the chassis frame.

### SUMMARY

The present disclosure has been invented to solve the above problems and is directed to providing a structure for preventing a rotation of a side sill, which mechanically couples a chassis frame to a vehicle body in the event of a side collision in a frame body vehicle, thereby preventing the rotation of the side sill and allowing the chassis frame and the vehicle body to be integrally deformed against the side collision.

In one embodiment of the present disclosure, a structure for preventing the rotation of a side sill may include a chassis frame, a vehicle body coupled to an upper portion of the chassis frame, side sills formed at both end portions of the vehicle body in a width direction of a vehicle, and a rotation prevention pin fixed to at least one side sill of the side sills. The rotation prevention pin is coupled to the chassis frame when the at least one side sill is pushed in the width direction of the vehicle.

The rotation prevention pin may be coupled to a lower surface of a side sill inner of the side sill or a lower surface of a side sill reinforcement connecting the side sill inner to a floor panel.

The rotation prevention pin may include an insertion portion inserted into the chassis frame, and a fixing portion coupling the rotation prevention pin to the side sill inner or the side sill reinforcement.

The insertion portion may be formed in a tapered shape in which a cross-sectional area increases from a front end portion to a rear end portion of the rotation prevention pin.

The structure for preventing the rotation of the side sill may further include a pin bracket coupled to the fixing portion while surrounding the fixing portion and fastened to the side sill inner or the side sill reinforcement.

In one embodiment, fastening holes are respectively formed in both end portions of the pin bracket, and fastening members are configured to insert into the fastening holes and fasten the pin bracket to the side sill inner or the side sill reinforcement.

The rotation prevention pin and the pin bracket may be coupled by welding.

A pinhole in which the rotation prevention pin is inserted into the chassis frame may be formed.

The insertion portion may be installed to be spaced apart from the pinhole with a gap.

When a side collision occurs, the side sill moves in the width direction of the vehicle and the rotation prevention pin may be coupled by being inserted into the pinhole.

In another embodiment, a guide is formed around the pinhole, and the guide is configured to extend in the width direction of the vehicle and guide the insertion of the insertion portion.

The pinhole may be formed on an outer surface of the chassis frame in the width direction.

In one embodiment, a plurality of pinholes may be formed in the chassis frame in a longitudinal direction of the vehicle and disposed at intervals. The rotation prevention pin may be installed at a position corresponding to a position of a pinhole among the plurality of pinholes.

In one embodiment, the side sill reinforcement may have an inner end portion in the width direction of the vehicle coupled to the lower surface of the floor panel, an outer end portion in the width direction of the vehicle coupled to the lower surface of the side sill inner, and a central portion formed with a flat portion to which the rotation prevention pin is fixed.

According to the structure for preventing the rotation of the side sill according to the present disclosure having the above configuration, since the rotation prevention pin is inserted into the pinhole, and the side sill of the vehicle body is constrained to the chassis frame in the event of the side collision, it is possible to prevent the phenomenon in which the side sill is rotated.

In addition, since the chassis frame and the vehicle body are deformed by the collision energy input in the event of the side collision, it is possible to secure the required side collision performance.

In addition, in the state in which the side collision does not occur, since the vehicle body is not firmly coupled to the chassis frame, it is possible to insulate the vibrations transmitted to the vehicle body.

### BRIEF DESCRIPTION OF THE DRAWINGS

In order that the disclosure may be well understood, there are now described various forms thereof, given by way of example, reference being made to the accompanying drawings, in which:

FIG. 1 is a bottom perspective view illustrating a structure for preventing a rotation of a side sill according to an embodiment of the present disclosure;

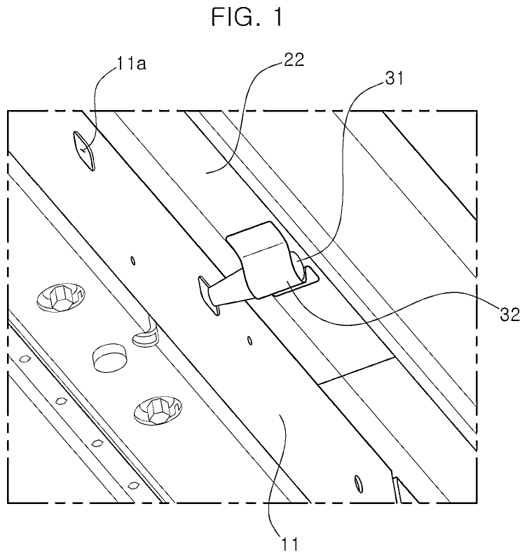

FIG. 2 is a cross-sectional view illustrating the structure for preventing the rotation of the side sill according to one embodiment of the present disclosure;

FIG. 3 is a cross-sectional view illustrating a structure for preventing the rotation of a side sill according to another embodiment of the present disclosure;

FIG. 4 is a perspective view illustrating a rotation prevention pin and a pin bracket applied to the structure for preventing the rotation of the side sill according to another embodiment of the present disclosure;

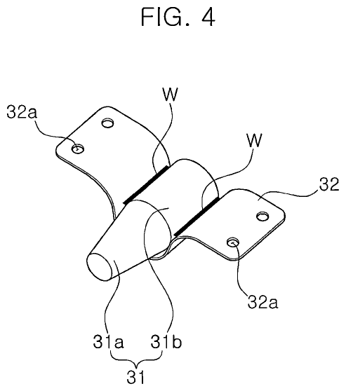

FIG. 5 is a cross-sectional view illustrating a state before a side collision of the structure for preventing the rotation of the side sill according to the present disclosure;

FIG. 6 is a bottom perspective view illustrating a state after the side collision of the structure for preventing the rotation of the side sill according to the present disclosure; and

FIG. 7 is a cross-sectional view illustrating the state after the side collision of the structure for preventing the rotation of the side sill according to the present disclosure.

The drawings described herein are for illustration purposes only and are not intended to limit the scope of the present disclosure in any way.

### DETAILED DESCRIPTION

Hereinafter, a structure for preventing the rotation of a side sill according to embodiments of the present disclosure is described in detail with reference to the accompanying drawings.

According to an embodiment of the present disclosure, a structure for preventing a rotation of a side sill of a vehicle may include a chassis frame 11, a vehicle body (20) coupled to an upper portion of the chassis frame 11, and side sills 21 formed on both end portions of the vehicle body 20 in a width direction of the vehicle, and a rotation prevention pin 31 fixed to the side sill 21. In particular, when the side sills 21 are pushed in the width direction of the vehicle, the rotation prevention pin 31 is configured to be coupled to the chassis frame 11.

Frame body type vehicles may be manufactured by coupling the vehicle body 20 to the upper portion of the chassis frame 11. Bushes for insulating vibrations may be installed between the chassis frame 11 and the vehicle body 20 at intervals to insulate vibrations between the chassis frame 11 and the vehicle body 20.

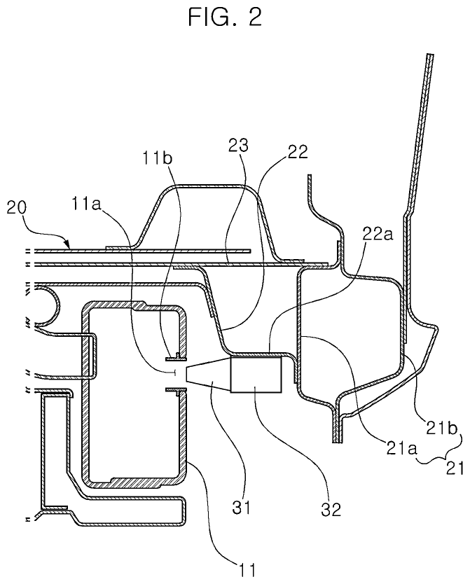

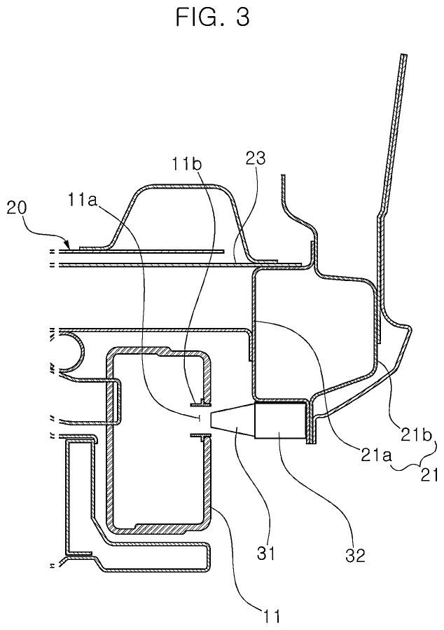

Describing a structure of both end portions of a portion of the vehicle body 20 coupled to the chassis frame 11, the side sills 21 may be connected to both end portions of a floor panel 23 forming an indoor floor of the vehicle. As illustrated in FIGS. 2-3, the side sill 21 may include a side sill inner 21a and a side sill outer 21b, which are bonded to each other at an upper end portion and a lower end portion thereof. In particular, the cross-section of the side sill inner 21a is inwardly convex toward the inside of the vehicle and the cross-section of the side sill outer 21b is outwardly convex toward the outside of the vehicle.

A side end portion of the floor panel 23 may be bonded to an upper surface of the side sill inner 21a.

In one embodiment, a side sill reinforcement 22 may connect a lower surface of the floor panel 23 to a lower surface of the side sill inner 21a. An inner end portion of the side sill reinforcement 22 may be coupled to the lower surface of the floor panel 23 in the width direction of the vehicle, and an outer end portion thereof may be coupled to the lower surface of the side sill inner 21a. The side sill reinforcement 22 may connect the floor panel 23 to the side sill inner 21a to reinforce the stiffness of the vehicle body 20 between the floor panel 23 and the side sill inner 21a.

The rotation prevention pin 31 may allow the side sill 21 to be constrained to, or engaged with the chassis frame 11 in the event of a side collision. In other words, the rotation prevention pin 31 may be installed on the side sill 21 to be coupled to the chassis frame 11 in the event of the side collision.

As illustrated in FIG. 3, the rotation prevention pin 31 may be disposed on one side of the side sill 21, as viewed in the width direction of the vehicle. In one embodiments, the rotation prevention pin 31 may be coupled to the lower surface of the side sill inner 21a or the side sill reinforcement 22.

The rotation prevention pin 31 may have an insertion portion 31a having a front portion inserted into the chassis frame 11 in the event of the side collision and a fixing portion 31b coupled to the side sill inner 21a or the side sill reinforcement 22.

The insertion portion 31a may be formed in a tapered shape to be easily inserted into the chassis frame 11. In other words, the insertion portion 31a may be formed to have the front end portion with the smallest cross-sectional area and a larger cross-sectional area toward a rear end portion thereof. Therefore, the insertion portion 31a may be easily inserted.

The fixing portion 31b may be formed to have a constant cross-sectional area. The rotation prevention pin 31 may be coupled to any one of the side sill inner 21a and the side sill reinforcement 22 using the fixing portion 31b.

In one embodiment, a pin bracket 32 may surround the rotation prevention pin 31 to be coupled to the side sill inner 21a or the side sill reinforcement 22.

The pin bracket 32 may surround the fixing portion 31b of the rotation prevention pin 31. In a state in which the pin bracket 32 surrounds the fixing portion 31b, the fixing portion 31b may be coupled to the pin bracket 32.

The pin bracket 32 and the rotation prevention pin 31 may be welded through welding, particularly, carbon dioxide (CO₂) welding. Since the pin bracket 32 and the rotation prevention pin 31 are coupled through carbon dioxide welding, a welding speed may be increased and slag may be prevented from being generated.

In another embodiment, fastening holes 32a for fastening the pin bracket 32 to the side sill inner 21a or the side sill reinforcement 22 may be formed at both end portions of the pin bracket 32. The rotation prevention pin 31 may be installed by allowing a fastening member such as a fastening bolt to pass through the fastening hole 32a to be fastened to the side sill inner 21a or the side sill reinforcement 22.

Here, describing a portion in which the rotation prevention pin 31 and the pin bracket 32 are installed, the pin bracket 32 may be installed to be coupled to the lower surface of the side sill inner 21a (see FIG. 3). When the side sill reinforcement 22 is not applied between the floor panel 23 and the side sill inner 21a, the pin bracket 32 may be coupled to the lower surface of the side sill inner 21a so that the rotation prevention pin 31 is installed on the lower surface of the side sill inner 21a.

In one embodiment, when the rotation prevention pin 31 and the pin bracket 32 are installed on the side sill reinforcement 22, a flat portion 22a may be formed in the middle of the side sill reinforcement 22 in the width direction and installed on the lower surface of the flat portion 22a (see FIG. 2). In other words, by coupling the pin bracket 32 to the lower surface of the flat portion 22a, the rotation prevention pin 31 may be installed on the side sill reinforcement 22.

A pinhole 11a into which the rotation prevention pin 31 is inserted in the width direction of the vehicle may be formed in the chassis frame 11. The pinhole 11a may be formed outside the chassis frame 11 in the width direction of the vehicle, which is formed in a substantially quadrangular cross-sectional shape.

The pinholes 11a may be formed in the chassis frame 11 at intervals in a longitudinal direction of the vehicle, and the rotation prevention pin 31 may be installed at a position corresponding to each pinhole 11a. In other words, a plurality of the rotation prevention pins 31 corresponding to the number of the pinholes 11a may be provided.

The rotation prevention pin 31 may not be inserted into the pinhole 11a when installed but may be spaced apart from the pinhole 11a with a gap. In other words, before the side collision, the rotation prevention pin 31 may not be inserted into the pinhole 11a, and thus the chassis frame 11 and the vehicle body 20 are in a state of being not firmly coupled. Therefore, the bush insulates vibrations.

Meanwhile, in the event of the side collision, the rotation prevention pins 31 may be inserted into the pinholes 11a at a plurality of points at the side end portion of the vehicle, thereby preventing the rotation of the side sill 21.

In another embodiment, a guide 11b may be formed around the pinhole 11a so that the rotation prevention pin 31 is easily inserted into the pinhole 11a when the side collision occurs. The guide 11b may be formed in the pinhole 11a to extend in the width direction of the vehicle. When the side collision occurs, the insertion portion 31a of the rotation prevention pin 31 may be in contact with the guide 11b and slides into the pinhole 11a.

An operation of the structure for preventing the rotation of the side sill according to the present disclosure having the above configuration is described as follows.

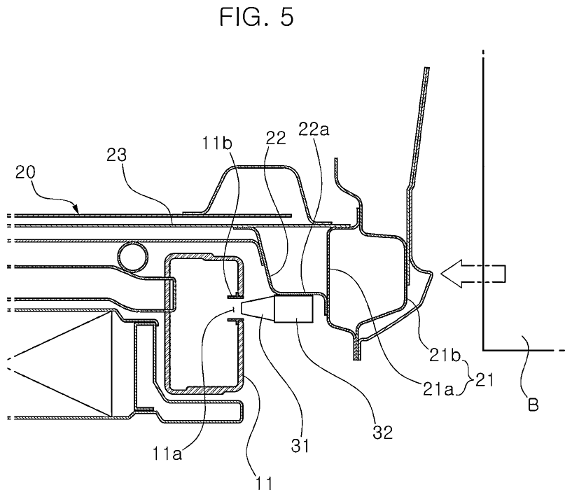

As illustrated in FIG. 5, before the side collision, the rotation prevention pin 31 is in a state of being spaced apart from the chassis frame 11 and being not inserted into the pinhole 11a.

In this state, since the chassis frame 11 and the vehicle body 20 are coupled to each other via bushes, vibrations, which are transmitted from the road surface to the vehicle body 20 according to the behavior of the vehicle, are insulated by the bushes provided between the chassis frame 11 and the vehicle body 20.

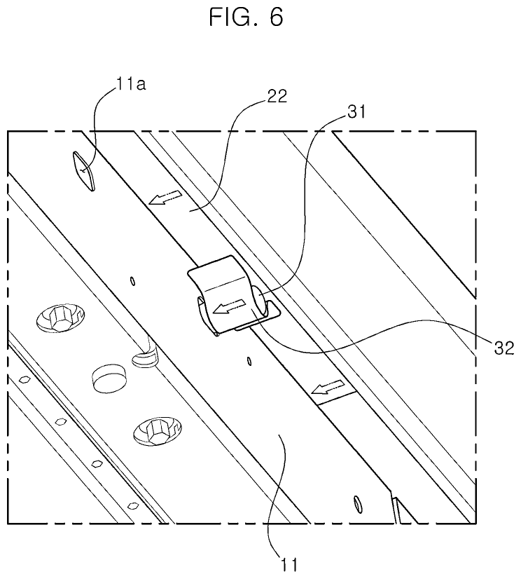

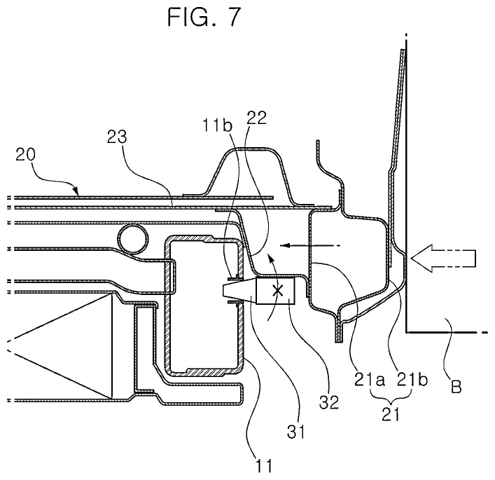

As illustrated in FIGS. 6 and 7, when the side collision occurs, the vehicle body 20 moves while being pushed by collision energy. For example, as illustrated in FIG. 7, when a collision test barrier B hits the side sill 21, the vehicle body 20 moves in a direction in which the collision energy is input.

Since the vehicle body 20 is coupled to the chassis frame 11 via the bushes, when the side surface of the vehicle body 20 is hit by the barrier B, the vehicle body 20 may move with respect to the chassis frame 11.

When the vehicle body 20 moves a certain distance, the vehicle body 20 may be firmly coupled to the chassis frame 11 while the rotation prevention pin 31 is inserted into the pinhole 11a. As described above, when the rotation prevention pin 31 is inserted into the pinhole 11a, the vehicle body 20 may no longer move from the chassis frame 11. In other words, when the rotation prevention pin 31 is inserted into the pinhole 11a, the side sill 21, a side end portion of the floor panel 23, the side sill reinforcement 22, and the like may no longer move from the chassis frame 11 and become an integrated structure with the chassis frame 11.

As described above, when the rotation prevention pin 31 is inserted into the pinhole 11a and the vehicle body 20 and the chassis frame 11 are integrated, a phenomenon in which the side sill 21 is rotated by the side collision may be prevented.

When the barrier B hits the side sill 21, the side sill 21 may try to be rotated by the collision energy input from the barrier B. However, since the rotation prevention pin 31 is inserted into the pinhole 11a, the side sill 21 may not rotate and may be in a state of being constrained to the chassis frame 11.

In this state, the side sill 21, the side sill reinforcement 22, and the floor panel 23 forming the vehicle body 20 are not separated from the chassis frame 11 and are integrally deformed by the collision energy.

Therefore, since it is possible to prevent a phenomenon in which the chassis frame 11 and the vehicle body 20 are individually and excessively deformed, it is possible to prevent the excessive deformation of the vehicle body 20 and reduce injuries to occupants.

What is claimed is:

1. A structure for preventing a rotation of a side sill of a vehicle, the structure comprising:
a chassis frame;
a vehicle body coupled to an upper portion of the chassis frame;
side sills formed at side end portions of the vehicle body in a width direction of the vehicle; and
a rotation prevention pin fixed to at least one side sill among the side sills and configured to be coupled to the chassis frame when the at least one side sill is pushed in the width direction of the vehicle.

2. The structure of claim 1, wherein the rotation prevention pin is coupled to a lower surface of a side sill inner of the at least one side sill or a lower surface of a side sill reinforcement connecting the side sill inner to a floor panel.

3. The structure of claim 2, wherein the rotation prevention pin includes:
an insertion portion inserted into the chassis frame; and
a fixing portion coupling the rotation prevention pin to the side sill inner or the side sill reinforcement.

4. The structure of claim 3, wherein the insertion portion is formed in a tapered shape in which a cross-sectional area increases from a front end portion to a rear end portion of the rotation prevention pin.

5. The structure of claim 3, further comprising a pin bracket coupled to the fixing portion while surrounding the fixing portion and fastened to the side sill inner or the side sill reinforcement.

6. The structure of claim 5, wherein fastening holes are respectively formed in end portions of the pin bracket, and fastening members are configured to insert into the fastening holes and fasten the pin bracket to the side sill inner or the side sill reinforcement.

7. The structure of claim 5, wherein the rotation prevention pin and the pin bracket are coupled by welding.

8. The structure of claim 3, wherein the rotation prevention pin is configured to insert into at least one pinhole formed in the chassis frame.

9. The structure of claim 8, wherein the insertion portion is installed to be spaced apart from the at least one pinhole with a gap.

10. The structure of claim 8, wherein when a side collision occurs, the at least one side sill moves in the width direction of the vehicle and the rotation prevention pin is coupled by being inserted into the at least one pinhole.

11. The structure of claim 8, wherein a guide is formed around the at least one pinhole, and the guide is configured to extend in the width direction of the vehicle and guide the insertion of the insertion portion.

12. The structure of claim 8, wherein the at least one pinhole is formed on an outer surface of the chassis frame.

13. The structure of claim 8, wherein the at least one pinhole comprises a plurality of pinholes, and pinholes of the plurality of pinholes are formed in the chassis frame in a longitudinal direction of the vehicle and disposed with intervals, and
wherein the rotation prevention pin is installed at a position corresponding to a position of a pinhole among the plurality of pinholes.

14. The structure of claim 2, wherein the side sill reinforcement comprises:
an inner end portion coupled to the lower surface of the floor panel in the width direction of the vehicle;
an outer end portion coupled to the lower surface of the side sill inner in the width direction of the vehicle; and
a central portion formed with a flat portion to which the rotation prevention pin is fixed.

15. A structure for preventing a rotation of a side sill of a vehicle, the structure comprising:
a chassis frame;
a vehicle body coupled to an upper portion of the chassis frame;
side sills formed at end portions of the vehicle body in a width direction of the vehicle; and
at least one rotation prevention pin fixed to at least one side sill of the side sills and configured to be coupled to the chassis frame when the at least one side sill is pushed in the width direction of the vehicle,
wherein the at least one rotation prevention pin includes:
an insertion portion inserted into the chassis frame; and
a fixing portion coupling the at least one rotation prevention pin to a side sill inner or a side sill reinforcement of the at least one side sill.

16. The structure of claim 15, further comprising a pin bracket coupled to the fixing portion while surrounding the fixing portion and fastened to the side sill inner or the side sill reinforcement.

17. The structure of claim 16, wherein the at least one rotation prevention pin is configured to be inserted into at least one pinhole formed in the chassis frame.

18. The structure of claim 17, wherein an insertion portion is installed to be spaced apart from the at least one pinhole with a gap.

19. The structure of claim 18, wherein the at least one pinhole is formed on an outer surface of the chassis frame.

20. The structure of claim 17, wherein the at least one pinhole comprises a plurality of pinholes, and pinholes of the plurality of pinholes are formed in the chassis frame in a longitudinal direction of the vehicle and disposed with intervals, and
wherein the at least one rotation prevention pin is installed at a position corresponding to a position of a pinhole among the plurality of pinholes.
